(19) United States
(12) Patent Application Publication
(10) Pub. No.: US 2018/0245658 A1
(43) Pub. Date: Aug. 30, 2018

(54) ENERGY TRANSFER APPARATUS AND METHOD OF USE

(71) Applicant: Holmes Solutions Limited Partnership, Wellington (NZ)

(72) Inventors: Andrew Karl DIEHL, Christchurch (NZ); John McCALLISTER, Christchurch (NZ); Mark THOMSON, Christchurch (NZ); Murray AITKEN, Christchurch (NZ); Stuart CLARK, Christchurch (NZ)

(73) Assignee: Holmes Solutions Limited Partnership, Wellington (NZ)

(21) Appl. No.: 15/559,021

(22) PCT Filed: Mar. 15, 2016
(86) PCT No.: PCT/NZ2016/050040

§ 371 Date: Sep. 15, 2017

(30) Foreign Application Priority Data
Mar. 15, 2015 (NZ) 705516

(51) Int. Cl. F16F 9/20; F16F 9/19; F16F 15/023

(52) U.S. Cl. CPC F16F 9/20; E04B 1/985; F16F 15/023; F16F 9/19

(57) ABSTRACT

Energy transfer apparatus such as a viscous damper or hydraulic cylinder apparatus are described along with their use, the apparatus generating velocity dependent damping force between two spatially separate points. The apparatus may comprise a system with a piston coupled to a rod shaft, the piston and rod shaft moving in a fitted, or sealed cylinder with end caps and fluid sealing elements at either end of the cylinder, the system containing fluid in at least one cavity located between the piston and cylinder and an accumulator fluidly connected to the at least one cavity. The rod shaft and piston move relative to the cylinder in the event of an imposed dynamic force and the accumulator counteracts over or under pressure in the at least one cavity.

### RELATED APPLICATIONS

This application derives priority from New Zealand patent application number 705516 incorporated herein by reference.

### TECHNICAL FIELD

Described herein is an energy transfer apparatus and method of use. More specifically, energy transfer apparatus such as a viscous damper or hydraulic cylinder apparatus are described along with their use, the apparatus transferring energy between internal hydraulic pressure and displacement force between two spatially separate points, the direction of energy transfer being application specific.

### BACKGROUND ART

Energy transfer apparatus are typically used in moving systems, the aim of the apparatus being to reduce, restrict or prevent movement occurring or, for rotating or oscillating systems, to reduce the natural resonant frequency of the rotation/oscillation. Damping or movement changes may reduce the movement to equilibrium as quickly as possible or instead may allow movement but at a reduced frequency and/or amplitude to the natural resonant frequency and/or returning the system gradually to an equilibrium. Alternatively the apparatus may be configured to apply force and displacement to external bodies and function as a motion actuator e.g. through fluid movement imposed by movement of a piston in a hydraulic cylinder.

For ease of discussion, viscous dampers are referred to below, however the same principles may be applied to other energy transfer apparatus such as a hydraulic cylinder.

Viscous damper apparatus utilise viscous drag forces from a fluid to slow or dampen the oscillatory motion occurring.

Dampers may be used in buildings to mitigate seismic oscillation. Such dampers may be fitted to key structural locations on or within a building and, in a seismic event, act to reduce any oscillation and prevent building damage. Dampers may be aligned in different directions to dampen lateral or vertical motion or dampen both lateral and vertical motion by transferring the energy elsewhere e.g. into a working fluid and/or into heat.

Existing dampers can have design issues and resulting draw backs.

For example, to couple a piston or plunger to a moving shaft, art apparatus may integrate the piston head with the shaft design or instead use fasteners to attach the piston to the shaft. Integration as one piece means the entire shaft and piston need to be removed and/or replaced in maintenance as opposed to simply replacing the piston or a part thereof. Fasteners are also not ideal as for example, localised stresses can occur about holes in the shaft to which fasteners are fitted. Removal of the piston also requires considerable time in having to remove and replace the fasteners.

A further issue with some damper apparatus includes the use of sliding seals. Sliding seals are prone to failure and require regular maintenance which is not ideal in building applications where the apparatus needs to be operable for as much time as possible.

A yet further problem is that art dampers may be large and unwieldy meaning they can only be used in certain larger layout building designs. Buildings may need to be more compact to suit higher value land prices and in seismic regions, buildings may have more structural beams, hence larger damper devices are less favourable or even impossible to integrate into designs.

It may be an advantage to address at least some of the above described disadvantages of art damper apparatus or at least provide the public with a choice.

Further aspects and advantages of the damper apparatus will become apparent from the ensuing description that is given by way of example only.

### SUMMARY

Described herein are are energy transfer apparatus such as a viscous damper or hydraulic cylinder apparatus along with their use, the apparatus generating velocity dependent damping force between two spatially separate points.

In a first aspect, there is provided an energy transfer apparatus comprising:
a system with a piston coupled to a rod shaft, the piston and rod shaft moving in a fitted, or sealed cylinder with end caps and fluid sealing elements at either end of the cylinder, the system containing fluid in at least one cavity located between the piston and cylinder and an accumulator fluidly connected to the at least one cavity;
wherein the rod shaft and piston move relative to the cylinder in the event of an imposed dynamic force; and
wherein the accumulator counteracts over or under pressure in the at least one cavity caused by:
(a) dynamic forces and/or thermal dissipation effect resulting from the oscillatory force and movement of the rod shaft and piston; as well as
(b) volume changes caused by environmental temperature change imposed on the system while in a static position.

In a second aspect, there is provided an energy transfer apparatus comprising:
a system with a piston coupled to a rod shaft, the piston and rod shaft moving in a fitted cylinder with end caps and fluid sealing elements at either end of the cylinder, the system containing fluid in at least one cavity located between the piston and cylinder and a low pressure accumulator fluidly connected to the at least one cavity;
wherein the rod shaft and piston move relative to the cylinder in the event of an imposed dynamic force; and
wherein the accumulator is at least partly incorporated into the rod shaft and which counteracts over or under pressure in the at least one cavity.

In a third aspect, there is provided an energy transfer apparatus comprising:
a system with a piston coupled to a rod shaft, the piston and rod shaft moving in a fitting cylinder with end caps and fluid sealing elements at either end of the cylinder, the system containing fluid in at least one cavity located between the piston and cylinder and a low pressure accumulator fluidly connected to the at least one cavity;
wherein the rod shaft and piston move relative to the cylinder in the event of an imposed dynamic force; and
wherein at least one valve member maintains communication between the accumulator and a lower pressure cavity or cavities during static and dynamic operation.

In a fourth aspect, there is provided an energy transfer apparatus comprising:
a system with a piston coupled to a rod shaft, the piston and rod shaft moving in a fitting cylinder with end caps and fluid sealing elements at either end of the cylinder, the system containing fluid in at least one cavity located between the piston and cylinder and a low pressure accumulator fluidly connected to the at least one cavity;
wherein the rod shaft and piston move relative to the cylinder in the event of an imposed dynamic force; and
wherein at least one valve member maintains communication between the accumulator and a lower pressure cavity or cavities, the at least one valve member being located on and/or within the piston.

In a fifth aspect, there is provided a method of damping a dynamic force imposed on a system, the method comprising the step of integrating at least one energy transfer apparatus substantially as described above with the system so as to dampen an imposed force acting on the system.

In a sixth aspect, there is provided an energy transfer apparatus comprising:
a rod shaft and at least one piston coupled to the rod shaft located about at least a region of the rod shaft longitudinal length, the piston and rod shaft moving in a fitting cylinder; and
wherein:
(a) the rod shaft and piston move relative to the cylinder in the event of an imposed dynamic force; and wherein an accumulator counteracts over or under pressure on one or both sides of the piston; and
(b) the at least one coupled piston is interference fitted to the rod shaft to prevent relative movement between the rod shaft and at least one coupled piston, coupling completed by a combination of:
   i. a clamping force imposed by the at least one coupled element on the shaft due to an imposed interference fit between at least part of the at least one coupled element and the shaft; and
   ii. a friction effect due to clamping about at least part of the at least one coupled element and the shaft facing surfaces.

Advantages of the above described energy transfer apparatus include for example:
Ease of manufacture—it is possible to construct the device as either an insert cartridge or machined directly into the piston.
Low manufacturing tolerances—no honed or fitted bores or precision sliding components.
Optionally the avoidance of sliding seals—compression only face seals can be used.
Fast switching action—can be used in high speed dynamic applications.
Flexible installation requirement—can be mounted in dynamically moving components.
Compact—can be machined directly into components to provide a compact arrangement.
High Pressure tolerance—possible to be used with high pressure differentials.
Debris tolerant—large part clearance for debris tolerance.

### BRIEF DESCRIPTION OF THE DRAWINGS

Further aspects of the energy transfer apparatus and method of use will become apparent from the following description that is given by way of example only and with reference to the accompanying drawings in which:

FIG. 1 illustrates a side cross-section drawing of an embodiment of a viscous damper apparatus;

FIG. 2 illustrates a perspective cross-section view of the viscous damper apparatus shown in FIG. 1;

FIG. 3 illustrates a detail perspective cross-section view of the viscous damper apparatus shown in FIG. 1 illustrating the accumulator reservoir;

FIG. 4 illustrates a further detail perspective cross-section view of the viscous damper apparatus shown in FIG. 1 illustrating the accumulator reservoir; and

FIG. 5 illustrates an alternative reservoir embodiment using a tank and volume pressurising means.

### DETAILED DESCRIPTION

As noted above, energy transfer apparatus such as a viscous damper or hydraulic cylinder apparatus are described along with their use, the apparatus generating velocity dependent damping force between two spatially separate points.

For the purposes of this specification, the term ‘about’ or ‘approximately’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘substantially’ or grammatical variations thereof refers to at least about 50%, for example 75%, 85%, 95% or 98%.

The term ‘comprise’ and grammatical variations thereof shall have an inclusive meaning—i.e. that it will be taken to mean an inclusion of not only the listed components it directly references, but also other non-specified components or elements.

The term ‘viscous damper’ or grammatical variations thereof refers to a device that offers resistance to motion achieved predominantly through the use of viscous drag behaviours, such that energy is transferred when the damper undergoes motion. Although viscous drag behaviours are noted here, those skilled in the art will appreciate that other methods are possible and as such, this definition should not be seen as limiting. It may be used in applications where impact damping or oscillatory damping is beneficial.

The term ‘hydraulic cylinder’ or grammatical variations thereof refers to a device that imposes a coupling force between members within a cylinder at least partially via one or more hydraulic forces.

The term ‘cylinder’ or grammatical variations thereof as used herein refers to a cylinder with a bore therein along the longitudinal axis of the cylinder.

The term ‘fastener’ or grammatical variations thereof as used herein refers to a mechanical fastener that joins or affixes two or more objects together. As used herein, this term excludes simple abutting or facing of materials and typically refers to a part or parts joining or affixing through obstruction. Non-limiting examples of fasteners include screws, bolts, nails, clips, dowels, cam locks, rope, string or wire.

The term ‘elastic displacement’ or grammatical variations thereof refers to a materials resistance to being displaced in shape elastically (i.e. non-permanently) when a force is applied to it and the ability of the material to recover this displacement when the force is removed. The modulus of elasticity of a material is defined as the slope of its stress-strain curve in the elastic displacement or deformation region.

The term ‘fits with interference’ or grammatical variations thereof refers to a connection between parts that is achieved by clamping pressure generated as the result of elastic displacement of the a part or parts when the part or parts undergo imposed dimensional change after the parts are overlaid together, rather than by any other means of fastening.

The terms ‘fits with friction’, ‘friction force’, ‘friction effect’, ‘friction fit’ or grammatical variations thereof refer to the face of the shaft and the face of the coupled element being frictionally held together, the connection made as a result of both interface pressure and the friction force resulting from the interface pressure.

The term ‘seal’ or grammatical variations thereof refers to a device or arrangement of features acting to form a barrier between two fluid volumes.

In a first aspect, there is provided an energy transfer apparatus comprising:
a system with a piston coupled to a rod shaft, the piston and rod shaft moving in a fitted, or sealed cylinder with end caps and fluid sealing elements at either end of the cylinder, the system containing fluid in at least one cavity located between the piston and cylinder and an accumulator fluidly connected to the at least one cavity;
wherein the rod shaft and piston move relative to the cylinder in the event of an imposed dynamic force; and
wherein the accumulator counteracts over or under pressure in the at least one cavity caused by:
(a) dynamic forces and/or thermal dissipation effect resulting from the oscillatory force and movement of the rod shaft and piston; as well as
(b) volume changes caused by environmental temperature change imposed on the system while in a static position.

In one embodiment, the energy transfer apparatus is a viscous damper. In this embodiment, the system is a closed system and force is imposed on the rod shaft causing movement of the piston and subsequent dampening of the rod shaft movement caused by transfer in energy from rod shaft kinetic energy to shear force generation and heat energy.

In an alternative embodiment, the energy transfer apparatus is a hydraulic cylinder. In this embodiment, the system is open so that hydraulic fluid for example from an external source may impose a force on the piston and rod shaft inside the cylinder thereby driving movement of the piston and rod shaft within the cylinder.

As noted above, the piston and rod shaft move in a fitted or sealed cylinder. The term ‘fitted’ or ‘sealed’ and grammatical variations thereof in this context refers to the piston or a part thereof substantially abutting the internal cylinder wall so as to form a restriction or seal between opposing sides of the piston.

As noted above, the apparatus comprises an accumulator to allow for pressure equalising across the system.

The accumulator may at least partly be incorporated into the rod shaft.

The accumulator may in one embodiment be fully integrated into the rod shaft.

The accumulator may comprise at least one gallery within the rod shaft in fluid communication with the at least one fluid cavity. The gallery may open to a fluid reservoir inside the rod shaft.

Alternatively, the gallery may open to a fluid reservoir outside the rod shaft.

In one embodiment, the reservoir may be volume variable by a movable piston sealingly located with the reservoir. The movable piston may be biased to maintain a predetermined pressure of fluid in the accumulator. The bias may be selected from a spring and/or a sealed gas cavity.

In an alternative embodiment, the reservoir may comprise a tank with a feed hose positioned below the fluid level at all times during operation, the accumulator action being through the raising and lowering of the fluid level in the reservoir. The fluid volume in the reservoir may be varied by a pressure imposing means selected from: a free-surface gas volume, gas bladder, bellows, closed cell foam, and combinations thereof.

The accumulator may be in constant communication with the fluid in the at least one cavity.

The apparatus described above may comprise at least one valve member that maintains communication between the accumulator and a lower pressure cavity or cavities during static and/or dynamic operation.

The at least one valve member may be located on the piston. The accumulator in this embodiment may be located inside or about the rod shaft.

In an alternative embodiment, the at least one valve member may instead be located on the cylinder and have passages from the cylinder wall to the at least one valve. In this embodiment, the accumulator may be mounted separate (ie separate to the rod and or piston) and be attached to the valve.

The at least one valve member may in one embodiment be at least one inverse shuttle valve. This should not be as limiting as other valve types may be used.

The at least one valve member may be an interlock between two check valves. The interlock may be formed from connected check valves so the valves oppositely close and open in unison. The interlock may alternatively be formed from unconnected check valves spaced so they close in unison but open independently. In selected embodiments, the at least one valve described above may only partially close thereby restricting flow but not stopping flow of fluid across the check valve. Further, the check valve stroke length may be varied to alter switch phasing.

The piston and rod shaft may have sufficient inertia to urge dynamic switching of the at least one valve member in the event of an imposed dynamic force on the piston and rod shaft. This may be useful to urge faster or slower switching of the at least one valve relative to piston and rod shaft movement and thereby alter the system dynamic response.

The at least one valve member may be biased to limit the onset of the valve action below a threshold pressure gradient. This variation may be useful to also change the system response and potentially introduce hysteresis to the system.

The rod shaft may move axially within the cylinder. The imposed dynamic force may be an oscillatory force.

In one embodiment, the piston may be a single sided piston with viscous fluid located on only one side of the piston. In an alternative embodiment, the piston may be a double sided piston with viscous fluid located on both sides of the piston.

Bearing elements may be present in the end caps to support lateral loads between the cylinder and the rod shaft.

The rod shaft may run the full length of the cylinder.

The piston may be coupled to at least one rod shaft directly or indirectly via at least one fastener. Alternatively, the piston may be coupled to the rod shaft by interference fitting the piston to the rod shaft at a point along the rod shaft longitudinal axis. A combination of both fastener use and interference fitting methods of coupling may also be used.

A force imposed on the rod shaft may be transferred to the piston or a force on the piston may be transferred to the rod shaft via the friction effect of the interference fit when used.

The piston may be interference fitted about two rod shaft endings, the first and second rod shafts jointly spanning the full length of the cylinder. This embodiment may be useful to link together two shafts in a driven and driving arrangement for example.

In one embodiment, at least one interference fit ring may be used to increase coupling between the rod shaft and piston.

The at least one cavity pressure imposed by a fluid in the cavity may impose a coupling force between the piston and rod shaft. This pressure may offer a significant clamping force coupling the piston to the rod shaft.

In a second aspect, there is provided an energy transfer apparatus comprising:
a system with a piston coupled to a rod shaft, the piston and rod shaft moving in a fitted cylinder with end caps and fluid sealing elements at either end of the cylinder, the system containing fluid in at least one cavity located between the piston and cylinder and a low pressure accumulator fluidly connected to the at least one cavity;
wherein the rod shaft and piston move relative to the cylinder in the event of an imposed dynamic force; and
wherein the accumulator is at least partly incorporated into the rod shaft and which counteracts over or under pressure in the at least one cavity.

In a third aspect, there is provided an energy transfer apparatus comprising:
a system with a piston coupled to a rod shaft, the piston and rod shaft moving in a fitted cylinder with end caps and fluid sealing elements at either end of the cylinder, the system containing fluid in at least one cavity located between the piston and cylinder and a low pressure accumulator fluidly connected to the at least one cavity;
wherein the rod shaft and piston move relative to the cylinder in the event of an imposed dynamic force; and
wherein at least one valve member maintains communication between the accumulator and a lower pressure cavity or cavities during static and dynamic operation.

In a fourth aspect, there is provided an energy transfer apparatus comprising:
a system with a piston coupled to a rod shaft, the piston and rod shaft moving in a fitted cylinder with end caps and fluid sealing elements at either end of the cylinder, the system containing fluid in at least one cavity located between the piston and cylinder and a low pressure accumulator fluidly connected to the at least one cavity;
wherein the rod shaft and piston move relative to the cylinder in the event of an imposed dynamic force; and
wherein at least one valve member maintains communication between the accumulator and a lower pressure cavity or cavities, the at least one valve member being located on and/or within the piston.

In a fifth aspect, there is provided a method of damping a dynamic force imposed on a system, the method comprising the step of integrating at least one energy transfer apparatus substantially as described above with the system so as to dampen an imposed force acting on the system.

The system in the above method may be a structural element or elements. For example, the system may be structural beams in a building and the energy transfer apparatus dampens seismic energy in the event of an earthquake.

In a sixth aspect, there is provided an energy transfer apparatus comprising:
a rod shaft and at least one piston coupled to the rod shaft located about at least a region of the rod shaft longitudinal length, the piston and rod shaft moving in a fitting cylinder; and
wherein:
(a) the rod shaft and piston move relative to the cylinder in the event of an imposed dynamic force; and wherein an accumulator counteracts over or under pressure on one or both sides of the piston; and
(b) the at least one coupled piston is interference fitted to the rod shaft to prevent relative movement between the rod shaft and at least one coupled piston, coupling completed by a combination of:
   i. a clamping force imposed by the at least one coupled element on the shaft due to an imposed interference fit between at least part of the at least one coupled element and the shaft; and
   ii. a friction effect due to clamping about at least part of the at least one coupled element and the shaft facing surfaces.

The above energy transfer apparatus offers an alternative means of coupling internal elements of the apparatus thereby minimising manufacturing cost and complexity.

In summary, the energy transfer apparatus described herein provides a means to
ensure accurate alignment of cylinder, rod and piston;
provide high structural rigidity under lateral rod loading;
seal the piston/shaft interface against fluid leakage;
provide high heat transfer capacity between piston and rod;
enable simple assembly of large devices.

Further, volume and hence temperature compensation is provided by the accumulator integrated into the rod optionally with a valve providing dynamic switching of the working cavity pressure to the low pressure side of the piston. This configuration provides for
compact installation;
simple pressure communication to the fluid cavity with integral drilled galleries;
fast dynamic switching; and
efficient use of materials.

Advantages of the above described energy transfer apparatus include for example:
Ease of manufacture—it is possible to construct the device as either an insert cartridge or machined directly into the piston.
Low manufacturing tolerances—no honed or fitted bores or precision sliding components.
Optionally the avoidance of sliding seals—only compression face seals can be used.
Fast switching action—can be used in high speed dynamic applications.
Flexible installation requirement—can be mounted in dynamically moving components.
Compact—can be machined directly into components to provide a compact arrangement.
High Pressure tolerance—possible to be used with high pressure differentials.
Debris tolerant—large part clearance for debris tolerance.

The embodiments described above may also be said broadly to consist in the parts, elements and features referred to or indicated in the specification of the application, individually or collectively, and any or all combinations of any two or more said parts, elements or features.

Further, where specific integers are mentioned herein which have known equivalents in the art to which the embodiments relate, such known equivalents are deemed to be incorporated herein as of individually set forth.

### WORKING EXAMPLES

The above described energy transfer apparatus and method of use is now described by reference to specific examples. For ease of discussion, viscous dampers are described in the examples however the principles relating to a viscous damper may be applied to other fluid circuit containing devices as well, for example a piston and/or hydraulic cylinder apparatus. Reference to a viscous damper application should not be seen as limiting.

### Example 1

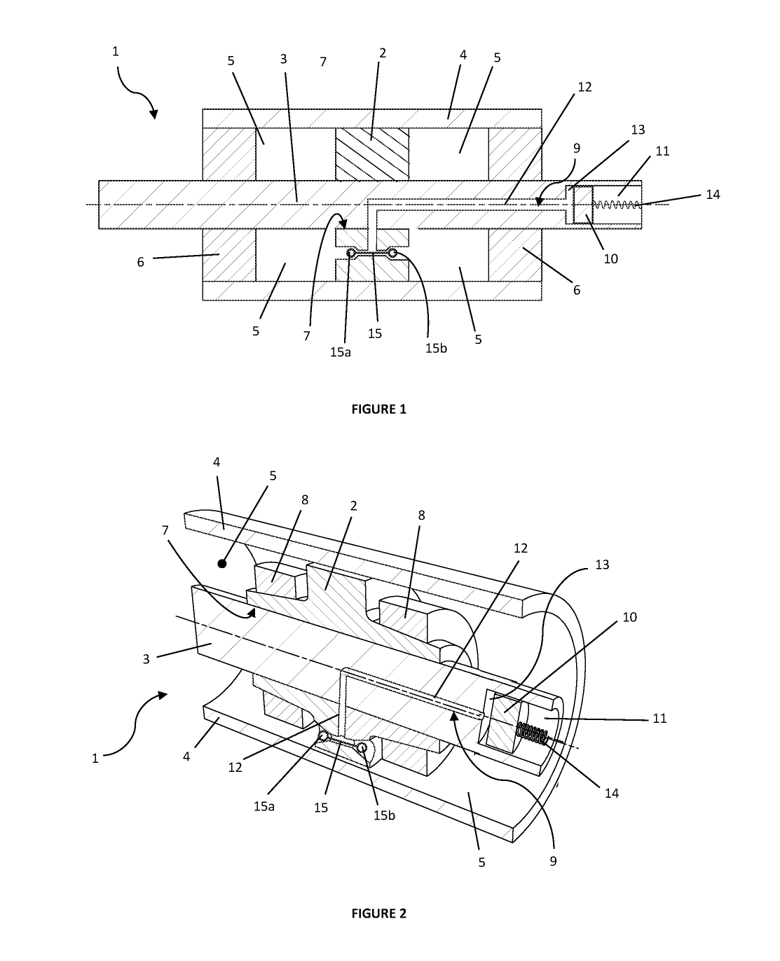

Referring to FIG. 1 and FIG. 2, the viscous damper apparatus 1 may in one embodiment consist of a piston 2 coupled to a rod shaft 3, the piston 2 and rod shaft 3 moving in a fitting cylinder 4 filled with a viscous fluid (not shown). The rod 3 passes through end caps 6, shown only in FIG. 1 for clarity, at the open ends of the cylinder 4, where fluid sealing elements (not shown) contain the fluid in a cavity or cavities 5 between the rod 3, piston 2 and cylinder 4. Bearing elements (not shown) may be present in the end caps 6 to support lateral loads between cylinder 4 and the rod 3.

The piston 2/rod 3 assembly may consist of a piston portion 2, interference fitted about an interference surface or interface 7 to a continuous rod 3 running the full length of the cylinder 4. The rod 3 may be of a continuous design to facilitate accurate alignment between the rod 3 and cylinder 4 and between rod 3 and piston 2 however the rod 3 may be a two-piece design, the choice of continuous or two-piece being dependent at least in part on the forces imposed on the apparatus 1.

Optionally, and as shown in FIG. 2, the piston 2 may have varying shapes (two examples shown in FIGS. 1 and 2) along with one or more clamping ring components 8 shown in FIG. 2. The clamping ring components 8 may provide additional means to increase the interference surface 7 between the rod 3 and piston 2 thereby transferring axial load from the piston 2 to the rod 3.

There are several benefits to such an integral construction including:
efficient means of ensuring the accurate alignment of cylinder 4, rod 3 and piston 2;
high structural rigidity under lateral rod 3 loading;
high heat transfer capability between piston 2 and rod 3;
rod shaft 3 interface across the piston 2 causes sealing across the piston 2 interference; and/or
a simple assembly process on large geometries.

Due to the nature of the apparatus 1, any hydrostatic volume change of the operating fluid (not shown) can lead to over-pressure or under-pressure of the cavity or cavities 5. A low pressure accumulator generally shown by arrow 9 is used to counteract these detrimental effects of volume change.

There are several possible sources of volume change. With single ended rod 3 arrangements, fluid volume changes with rod 3 stroke—a double ended rod 3 arrangement negates fluid volume change with piston 2 stroke and thereby reduces the required capacity of the accumulator 9. Environmental and operational temperature variations are also critical effects, affecting both the material container volume and the fluid volume.

Referring to FIGS. 1 and 2 again, the accumulator 9 may be incorporated into the rod shaft 3 by means of a movable accumulator piston 10 in an accumulator cylinder 11 formed within the rod 3. Integration into the rod 3 is optional but may provide for several benefits including providing a compact assembly that minimises component count compared to a separate accumulator 9 and also allows for simple pressure communication to the fluid cavity or cavities 5 via drilled galleries 12 in one or both of the piston 2 and rod shaft 3.

The accumulator 9 may have a reservoir portion 13 that houses fluid (not shown). Fluid movement in the reservoir 13 may be driven by the accumulator piston 10, the piston having pressure seals (not shown) capable of sealing the full device pressure. A spring 14 optionally also with a sealed gas cavity (not shown) may be positioned behind the piston 2 that preloads the piston 2 to counter friction of the piston 2 seal or seals (not shown).

Under normal operation the accumulator 9 piston 10 may move in response to volume changes from environmental temperature change; it also has sufficient capacity to accommodate the volume change from the full thermal dissipation of dynamic shock absorption. Further, the accumulator 9 may be in constant communication with fluid (not shown) in the cylinder cavity or cavities 5, cavity 5 pressure on either side of the piston 2 varying from ambient to working pressure with stroke direction. A means is required to connect the accumulator 9 to the low pressure side of the piston 2 during both static and dynamic operation. This may be achieved through the use of an inverse shuttle valve 15. The inverse shuttle valve 15 may be accommodated in the piston 2 communicating with the accumulator 9 by drilled galleries 12 in the piston 2 and shaft 3. The inverse shuttle valve 15 may have opposing check valves 15a, 15b linked via a pin. With such a device the accumulator 9 only sees the full operating pressure of the apparatus 1 under proof pressure testing. The inertia effects resulting from the valve 15 being located across a moving piston 2 provides for improved dynamic switching although this is not essential.

### Example 2

The arrangement shown above is a moving piston 2 installation, the valve(s) 15 formed as part of the piston 2. By putting pressure ports or drilled galleries (not shown) in the rod 3, the valve 15 arrangement can be accommodated in the rod 3 and separate to the piston 2. Alternatively, external ports (not shown) may be located in the cylinder 4 and the valve 15 may be fitted external to the cylinder 4 tube. Valve 15 positioning and placement may therefore be varied.

### Example 3

Another variation relates to the interlock between the valve 15 check valves 15a, 15b. This interlock may take several forms including:
connected check valves 15a, 15b so the valves 15a, 15b close and open in unison (e.g. achieved by use of a connecting fixed length pin);
unconnected check valves 15a, 15b spaced so they close in unison but open independently.

In another variation, the check valve 15a, 15b stroke length may be varied to alter switch phasing.

Further, the check valve or valves 15a, 15b may either close completely or only partly close thereby restricting or halting flow.

### Example 4

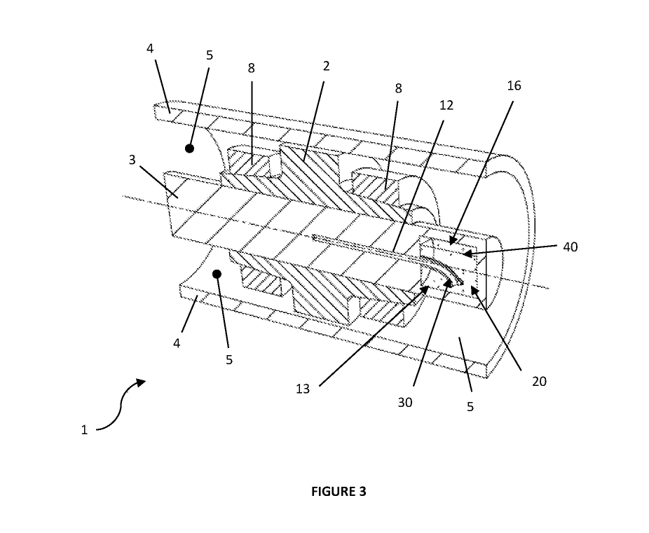

Accumulators 9 without accumulator pistons 10 may be utilised. Referring to FIG. 3, the piston 10 and spring 14 in the accumulator 9 of FIGS. 1 and 2 are substituted with an alternative fluid changing means. For clarity, the piston gallery and valve are removed from FIG. 3. As shown in FIG. 3, a gas bladder or bellows or closed cell foam in opening 16 applies pressure on a fluid 20 in the accumulator 9 reservoir 13 thereby altering the fluid 20 volume and pressure in the reservoir 13. As shown in FIG. 3, the accumulator 9 may comprise of a reservoir 13 in the shape of a tank with feed hose 30 positioned below the fluid 20 level 40 at all times during operation, the accumulator action being through the raising and lowering of the fluid 20 level 40 in the reservoir 13.

The embodiments described above may also be said broadly to consist in the parts, elements and features referred to or indicated in the specification of the application, individually or collectively, and any or all combinations of any two or more said parts, elements or features, and where specific integers are mentioned herein which have known equivalents in the art to which the embodiments relates, such known equivalents are deemed to be incorporated herein as of individually set forth,

Where specific integers are mentioned herein which have known equivalents in the art to which this invention relates, such known equivalents are deemed to be incorporated herein as if individually set forth.

Aspects of the energy transfer apparatus and methods of use have been described by way of example only and it should be appreciated that modifications and additions may be made thereto.

What is claimed is:

1. An energy transfer apparatus comprising:
a system with a piston coupled to a rod shaft, the piston and rod shaft moving in a fitted, or sealed cylinder with end caps and fluid sealing elements at either end of the cylinder, the system containing fluid in at least one cavity located between the piston and cylinder and an accumulator fluidly connected to the at least one cavity;
wherein the rod shaft and piston move relative to the cylinder in the event of an imposed dynamic force; and
wherein the accumulator counteracts over or under pressure in the at least one cavity caused by:
(a) dynamic forces and/or thermal dissipation effect resulting from the oscillatory force and movement of the rod shaft and piston; as well as
(b) volume changes caused by environmental temperature change imposed on the system while in a static position.

2. The energy transfer apparatus as claimed in claim 1 wherein the accumulator is at least partly incorporated into the rod shaft.

3. The energy transfer apparatus as claimed in claim 1 or claim 2 wherein the accumulator is fully integrated into the rod shaft.

4. The energy transfer apparatus as claimed in any one of the above claims wherein the accumulator comprises at least one gallery within the rod shaft in fluid communication with the at least one fluid cavity.

5. The energy transfer apparatus as claimed in any one of the above claims wherein the gallery opens to a fluid reservoir inside the rod shaft.

6. The energy transfer apparatus as claimed in any one of claims 1 to 4 wherein the gallery opens to a fluid reservoir outside the rod shaft.

7. The energy transfer apparatus as claimed in claim 5 or claim 6 wherein the reservoir is volume variable by a movable piston sealingly located with the reservoir.

8. The energy transfer apparatus as claimed in claim 7 wherein the movable piston is biased to maintain a predetermined pressure of fluid in the accumulator.

9. The energy transfer apparatus as claimed in claim 8 wherein the bias is selected from a spring and/or a sealed gas cavity.

10. The energy transfer apparatus as claimed in claim 5 or claim 6 wherein the reservoir comprises a tank with a feed hose positioned below the fluid level at all times during operation, the accumulator action being through the raising and lowering of the fluid level in the reservoir.

11. The energy transfer apparatus as claimed in claims 2 to 6 and claim 10 wherein the fluid volume in the reservoir is varied by a pressure imposing means selected from: a free-surface gas volume, gas bladder, bellows, closed cell foam, and combinations thereof.

12. The energy transfer apparatus as claimed in any one of the above claims wherein the accumulator is in constant communication with the fluid in the at least one cavity.

13. The energy transfer apparatus as claimed in any one of the above claims wherein the apparatus comprises at least one valve member that maintains communication between the accumulator and a lower pressure cavity or cavities during static and/or dynamic operation.

14. The energy transfer apparatus as claimed in claim 13 wherein the at least one valve member is located on the piston.

15. The energy transfer apparatus as claimed in claim 13 or claim 14 wherein the at least one valve member is at least one inverse shuttle valve.

16. The energy transfer apparatus as claimed in claim 14 or claim 15 wherein the at least one valve member is an interlock between two check valves.

17. The energy transfer apparatus as claimed in claim 16 wherein the interlock is formed from connected check valves so the valves oppositely close and open in unison.

18. The energy transfer apparatus as claimed in claim 16 wherein the interlock is formed from unconnected check valves spaced so they close in unison but open independently.

19. The energy transfer apparatus as claimed in claim 17 or claim 18 wherein the valve only partially closes thereby restricting flow but not stopping flow of fluid across the check valve.

20. The energy transfer apparatus as claimed in any one of claims 16 to 19 wherein the check valve stroke length is varied to alter switch phasing.

21. The energy transfer apparatus as claimed in any one of claims 13 to 20 wherein the piston and rod shaft have sufficient inertia to urge dynamic switching of the at least one valve member in the event of an imposed dynamic force on the piston and rod shaft.

22. The energy transfer apparatus as claimed in any one of claims 13 to 21 wherein the at least one valve member is biased to limit the onset of the valve action below a threshold pressure gradient.

23. The energy transfer apparatus as claimed in any one of the above claims wherein the rod shaft moves axially within the cylinder.

24. The energy transfer apparatus as claimed in any one of the above claims wherein the imposed dynamic force is an oscillatory force.

25. The energy transfer apparatus as claimed in any one of the above claims wherein the piston is a single sided piston with viscous fluid located on only one side of the piston.

26. The energy transfer apparatus as claimed in any one of claims 1 to 24 wherein the piston is a double sided piston with viscous fluid located on both sides of the piston.

27. The energy transfer apparatus as claimed in any one of the above claims wherein bearing elements are present in the end caps to support lateral loads between the cylinder and the rod shaft.

28. The energy transfer apparatus as claimed in any one of the above claims wherein the rod shaft runs the full length of the cylinder.

29. The energy transfer apparatus as claimed in any one of the above claims wherein the piston is coupled to at least one rod shaft directly or indirectly via at least one fastener.

30. The energy transfer apparatus as claimed in any one of the above claims wherein the piston is coupled to the rod shaft by interference fitting the piston to the rod shaft at a point along the rod shaft longitudinal axis.

31. The energy transfer apparatus as claimed in claim 30 wherein a force imposed on the rod shaft is transferred to the piston or a force on the piston is transferred to the rod shaft via the friction effect of the interference fit.

32. The energy transfer apparatus as claimed in claim 30 or 31 wherein the piston is interference fitted about two rod shaft endings, the first and second rod shafts jointly spanning the full length of the cylinder.

33. The energy transfer apparatus as claimed in any one of the above claims wherein at least one interference fit ring is used to increase coupling between the rod shaft and piston.

34. The energy transfer apparatus as claimed in any one of the above claims wherein the at least one cavity pressure imposes a coupling force between the piston and rod shaft.

35. An energy transfer apparatus comprising:
a system with a piston coupled to a rod shaft, the piston and rod shaft moving in a fitted cylinder with end caps and fluid sealing elements at either end of the cylinder, the system containing fluid in at least one cavity located between the piston and cylinder and a low pressure accumulator fluidly connected to the at least one cavity;
wherein the rod shaft and piston move relative to the cylinder in the event of an imposed dynamic force; and
wherein the accumulator is at least partly incorporated into the rod shaft and which counteracts over or under pressure in the at least one cavity.

36. An energy transfer apparatus comprising:
a system with a piston coupled to a rod shaft, the piston and rod shaft moving in a fitted cylinder with end caps and fluid sealing elements at either end of the cylinder, the system containing fluid in at least one cavity located between the piston and cylinder and a low pressure accumulator fluidly connected to the at least one cavity;
wherein the rod shaft and piston move relative to the cylinder in the event of an imposed dynamic force; and
wherein at least one valve member maintains communication between the accumulator and a lower pressure cavity or cavities during static and dynamic operation.

37. An energy transfer apparatus comprising:
a system with a piston coupled to a rod shaft, the piston and rod shaft moving in a fitted cylinder with end caps and fluid sealing elements at either end of the cylinder, the system containing fluid in at least one cavity located between the piston and cylinder and a low pressure accumulator fluidly connected to the at least one cavity;
wherein the rod shaft and piston move relative to the cylinder in the event of an imposed dynamic force; and
wherein at least one valve member maintains communication between the accumulator and a lower pressure cavity or cavities, the at least one valve member being located on and/or within the piston.

38. An energy transfer apparatus comprising:
a rod shaft and at least one piston coupled to the rod shaft located about at least a region of the rod shaft longitudinal length, the piston and rod shaft moving in a fitted cylinder; and
wherein:
(a) the rod shaft and piston move relative to the cylinder in the event of an imposed dynamic force; and wherein an accumulator counteracts over or under pressure on one or both sides of the piston; and
(b) the at least one coupled piston is interference fitted to the rod shaft to prevent relative movement between the rod shaft and at least one coupled piston, coupling completed by a combination of:
i. a clamping force imposed by the at least one coupled element on the shaft due to an imposed interference fit between at least part of the at least one coupled element and the shaft; and
ii. a friction effect due to clamping about at least part of the at least one coupled element and the shaft facing surfaces.

39. The energy transfer apparatus as claimed in any one of the above claims wherein the energy transfer apparatus is a viscous damper

40. The energy transfer apparatus as claimed in any one of the above claims wherein the energy transfer apparatus is a hydraulic cylinder.

41. A method of damping a dynamic force imposed on a system, the method comprising the step of integrating at least one energy transfer apparatus as claimed in any one of the above claims with the system so as to dampen the oscillation force acting on the system.

42. The method as claimed in claim 41 wherein the system is a structural element.
